(19) United States
(12) Patent Application Publication
(10) Pub. No.: US 2005/0255373 A1
(43) Pub. Date: Nov. 17, 2005

(54) Liquid fuel feed fuel cell, electrode for fuel cell and methods for manufacturing same

(76) Inventors: Hidekazu Kimura, Tokyo (JP); Tsutomu Yoshitake, Tokyo (JP); Sadanori Kuroshima, Tokyo (JP); Shin Nakamura, Tokyo (JP); Yuichi Shimakawa, Tokyo (JP); Takashi Manako, Tokyo (JP); Hideto Imai, Tokyo (JP); Suguru Watanabe, Tokyo (JP); Yoshimi Kubo, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 10/519,948

(22) PCT Filed: Jul. 2, 2003
(86) PCT No.: PCT/JP03/08419

§ 371 Date: Dec. 29, 2004

(30) Foreign Application Priority Data
Jul. 3, 2002 (JP) 2002-194167

(51) Int. Cl. H01M 4/86; H01M 4/96; B05D 5/12; H01M 4/88

(52) U.S. Cl. 429/44; 429/42; 502/101; 427/115

(57) ABSTRACT

To provide a liquid fuel supply type fuel cell in which water present in the oxidizer electrode is promptly removed and evaporated, thereby achieving high output, a fuel cell electrode, and methods for manufacturing the same. In a fuel cell 100, a base material 110 is provided with a hydrophobic layer 441 on the surface in contact with a catalyst layer 112 for discharging water promptly, and a hydrophilic layer 443 from the hydrophobic layer 441 towards the outside of the cell for evaporating water which has passed through the hydrophobic layer 441 from the surface.

### TECHNICAL FIELD

The present invention relates to a fuel cell, a fuel cell electrode, and methods for manufacturing the same. More particularly, the present invention relates to a liquid fuel supply type fuel cell.

### BACKGROUND ART

A solid electrolyte fuel cell comprises a fuel electrode and an oxidizer electrode, and a solid electrolyte membrane placed between them. The fuel electrode is supplied with fuel, while the oxidizer electrode is supplied with oxidizer to generate electric power through an electrochemical reaction. Each of the electrodes includes a base material and a catalyst layer on the surface of the base material. As fuel, hydrogen has been generally utilized. In recent years, however, through the use of methanol being inexpensive and easy to handle as raw material, a methanol reforming type fuel cell, in which methanol is reformed to generate hydrogen, and a direct methanol type fuel cell, in which methanol is directly used as fuel, have been extensively developed.

In the case of using hydrogen as fuel, a reaction in the fuel electrode is represented by the following Expression (1).
3H₂→6H⁺+6e⁻ (1)

In the case of using methanol as fuel, a reaction in the fuel electrode is represented by the following Expression (2).
CH₃OH+H₂O→6H⁺+CO₂+6e⁻ (2)

In both the cases, a reaction in the oxidizer electrode is represented by the following Expression (3).
3/2O₂+6H⁺+6e⁻→3H₂O (3)

Especially, the direct methanol type fuel cell, in which hydrogen ions are obtained from a methanol solution, requires no reformer or the like and can be smaller and lighter, thus having the big advantage of being applicable to portable electronic equipment.

In addition, very high energy density is achieved since a methanol solution in liquid form is used as fuel. Besides, as compared to gas fuel such as hydrogen gas and hydrocarbon gas, organic liquid fuel can be transported easily and safely.

In a fuel cell having the construction as above described, hydrogen gas or methanol supplied to the fuel electrode reaches a catalyst through fine pores in the electrode, and is decomposed into electrons and hydrogen ions (Expressions (1) and (2)). The electrons are led out to an external circuit through carbon particles and the base material within the fuel electrode, and flows into the oxidizer electrode from the external circuit.

On the other hand, the hydrogen ions generated in the fuel electrode reach the oxidizer electrode through a solid polyelectrolyte in the fuel electrode and the solid electrolyte membrane placed between both the electrodes, and react with oxygen supplied to the oxidizer electrode and the electrons flowing into the oxidizer electrode through the external circuit to produce water as shown in Expression (3). As a result, the electrons flow from the fuel electrode to the oxidizer electrode in the external circuit, and electric power is derived.

In order to improve the characteristics of a fuel cell having the above construction, water produced in the oxidizer electrode needs to be promptly evaporated therefrom and removed. The water that remains in the oxidizer electrode blocks a gas diffusion path, thus inhibiting the diffusion of gases. Accordingly, reaction efficiency in Expression (3) declines.

When a proton-exchange membrane or a solid polymer membrane is employed as a solid electrolyte membrane, it is known that, in addition to water produced by a redox reaction, the movement of water accompanies the migration of hydrogen ions generated in the fuel electrode. The water, which moves with the hydrogen ions, reaches from the fuel electrode to the oxidizer electrode through the solid electrolyte membrane. Besides, in a fuel cell using organic liquid fuel, water contained in the fuel moves to reach the oxidizer electrode. Therefore, in such a fuel cell, it is necessary to improve efficiency in the discharge of water from the oxidizer electrode. Especially, a liquid fuel supply type fuel cell requires further improvement in the efficiency.

In the case of a fuel cell supplied with gas as fuel, the following are known as methods for discharging water produced in the oxidizer electrode.

In Japanese Patent Application laid open No. HEI9-245800, for example, there is described a fuel cell supplied with gas fuel, in which hydrophilic treatment is applied to a base material constituting an oxidizer electrode, and water repellent treatment is applied to the surface of the base material in contact with a catalyst layer or both the surfaces of the base material.

Further, in Japanese Patent Application laid open No. 2001-52717, there is found a method of enhancing the output of a fuel cell by adjustment of the average hole diameter in combination with the water repellent treatment applied to the surface(s) of the oxidizer electrode described in Japanese Patent Application laid open No. HE19-245800.

Still further, in Japanese Patent Application laid open No. HEI11-135132, there is described a fuel cell provided with an oxidizer electrode including as base materials two or more water repellent porous carbon flat plates stacked one upon another.

### PROBLEMS THAT THE INVENTION IS TO SOLVE

However, the improved conventional techniques mentioned above are concerned with a fuel cell supplied with gas as fuel, and are not wholly effective when applied to a fuel cell supplied with liquid as fuel.

For example, according to the technique described in Japanese Patent Application laid open No. HEI9-245800, the water repellent layer is provided on the surface of the base material in contact with the catalyst layer for discharging water in the catalyst layer. In the fuel cell, the fuel electrode is supplied with gas, and, in order to increase the humidity of an electrolyte membrane on the side of the oxidizer electrode, water is repelled by the water repellent layer on the side of the catalyst layer and is pushed back to the electrolyte membrane. That is, water in the catalyst layer is discharged in two directions, into the base material or to the electrolyte membrane by reverse osmosis. On the other hand, in a fuel cell having a fuel electrode supplied with organic liquid fuel, the humidity of a solid electrolyte membrane can be ensured, and therefore, water in a catalyst layer must be discharged mainly into a base material. Besides, in a fuel cell having a fuel electrode supplied with organic liquid fuel, water, including water contained in the fuel, needs to be further efficiently evaporated out of the cell and removed as compared to a fuel cell supplied with gas as fuel.

Additionally, according to the above patent application, in the fuel cell, when the base material is provided with the water repellent layers on both the surfaces, water generated in the catalyst layer is more easily pushed back to the electrolyte membrane on the catalyst layer side of the base material of the oxidizer electrode. That is, in the case where the base material of the oxidizer electrode is provided with the water repellent layers on both the surfaces, water led into the base material is absorbed into the electrolyte membrane by reverse osmosis. The water led into the base material may easily evaporate from the water repellent part on the surface of the base material. However, the technique is not aimed at improving efficiency in the discharge of water in the catalyst layer into the base material.

Further, since the hydrophilic treatment and the formation of the water repellent layer are performed with nonconductive materials, it is difficult to apply the technique to a high-power fuel cell.

According to the technique described in Japanese Patent Application laid open No. 2001-52717, the average hole diameter is adjusted so that an oxidizing agent is supplied uniformly to a catalyst layer from the base material of a fuel electrode. However, the technique is not aimed at improving efficiency in the discharge of water in the catalyst layer into the base material. Also in the fuel cell, the fuel electrode is supplied with gas, and therefore, water in the catalyst layer is mainly absorbed into an electrolyte membrane by reverse osmosis.

According to the technique described in Japanese Patent Application laid open No. HEI11-135132, two or more base materials are stacked one upon another, which increases the thickness of the base materials and prevents a reduction in the size of the fuel cell.

Besides, in order to bond the stacked base materials and maintain electrical contact, a measure, for example, sintering of the base materials is necessary. However, sintering of carbon is usually performed at a high temperature around 1000° C., which is far higher than the heat resistance of PTFE (polytetrafluoroethylene) used for water repellent treatment. Consequently, the base materials cannot be sintered, and good electrical contact cannot be achieved. Thus, it is difficult to apply the technique to a high-power fuel cell.

As is described above, in the conventional fuel cells in which the fuel electrode is supplied with gas, water is not efficiently discharged in the direction from the catalyst layer to the base material of the oxidizer electrode. Accordingly, the water is pushed back to the electrolyte membrane, which decreases efficiency in the evaporation of water from the surface of the base material of the oxidizer electrode. In addition, it has been difficult to achieve improvement in output characteristics as well as reduction in the size of the fuel cell. A liquid fuel supply type fuel cell, however, requires higher-level water discharge efficiency in the oxidizer electrode. With the difference between a liquid fuel supply type fuel cell and a fuel cell supplied with gas as fuel, it is necessary to resolve the problem concerning the discharge and removal of water present in the oxidizer electrode.

In view of the foregoing, the technical problem for the present invention is to discharge water present in the oxidizer electrode of a liquid fuel supply type fuel cell promptly to the surface of the base material of the oxidizer electrode and evaporate the water.

It is therefore an object of the present invention to provide a fuel cell in which water present in the oxidizer electrode is promptly removed and evaporated, a fuel cell electrode, and methods for manufacturing the same.

It is another object of the present invention to provide a fuel cell having a fuel electrode supplied with liquid fuel in which water present in the oxidizer electrode is promptly removed and evaporated to produce high output, catalyst electrodes, and methods for manufacturing the same.

### DISCLOSURE OF THE INVENTION

In accordance with the present invention, there is provided a fuel cell comprising a solid electrolyte membrane, a fuel electrode and an oxidizer electrode with the solid electrolyte membrane between them, and a liquid fuel supply section for supplying liquid fuel to the fuel electrode, wherein the oxidizer electrode includes a base material and a catalyst layer formed between the base material and the solid electrolyte membrane, and the base material includes therein a first layer having hydrophobic properties and a second layer having hydrophilic properties arranged in this order in the direction from the catalyst layer side to the outside of the cell.

Incidentally, the direction to “the outside of the cell” indicates the direction away from the solid electrolyte membrane.

The fuel cell of the present invention has a construction in which the first layer having hydrophobic properties and the second layer having hydrophilic properties are arranged in this order in the direction from the catalyst layer side to the outside of the cell in the base material of the oxidizer electrode. By virtue of this construction, water produced by a redox reaction (Expression (3)) in the catalyst layer and water contained in the fuel, etc., which moves with hydrogen ions to the oxidizer electrode, can be efficiently led from the first layer into the base material. Thus, the water can evaporate quickly from the surface of the second layer.

Consequently, water in the oxidizer electrode can be promptly removed, and a gas diffusion path in the oxidizer electrode can be secured. Thereby, the output of the fuel cell can be enhanced.

Incidentally, in the fuel cell of the present invention, the hydrophilic second layer may be provided in the entire base material or may be provided only in the vicinity of the surface as long as it is placed more away from the solid electrolyte membrane than the hydrophobic first layer.

Further, the fuel cell of the present invention has a construction in which the first and second layers are provided in one base material constituting the oxidizer electrode. Thus, the fuel cell can be smaller and lighter.

In accordance with the present invention, there is provided a fuel cell electrode for a liquid fuel supply type fuel cell, comprising a base material and a catalyst layer formed on one surface of the base material, wherein the base material includes therein a first layer having hydrophobic properties and a second layer having hydrophilic properties arranged in this order from the catalyst layer side in the direction away from the catalyst layer.

The fuel cell electrode of the present invention has a construction in which the first layer having hydrophobic properties and the second layer having hydrophilic properties are arranged in this order from the catalyst layer side in the direction away from the catalyst layer in the base material. By virtue of this construction, when the electrode is used for a fuel cell, water produced by a redox reaction (Expression (3)) in the catalyst layer, water contained in the fuel, etc., which moves with hydrogen ions to the electrode, can be efficiently led from the first layer into the base material. Thus, the water can evaporate quickly from the surface of the second layer.

Consequently, water in the oxidizer electrode can be promptly removed, and a gas diffusion path in the electrode can be secured. Thereby, when the electrode is used for a fuel cell, the output of the fuel cell can be enhanced.

Further, the fuel cell electrode of the present invention has a construction in which the first and second layers are provided in one base material constituting the oxidizer electrode. Thus, the fuel cell as well as the fuel cell electrode can be smaller and lighter.

In accordance with the present invention, there is provided a method for manufacturing an electrode for a liquid fuel supply type fuel cell, comprising the steps of forming a hydrophobic layer on one surface of a base material, forming a hydrophilic layer on the other surface of the base material, and forming a catalyst layer by coating the surface of the hydrophobic layer with paint containing conductive particles holding catalyst material and particles including a solid polyelectrolyte.

According to the method for manufacturing a fuel cell electrode, it is possible to manufacture a fuel cell electrode in which a first layer having hydrophobic properties and a second layer having hydrophilic properties are arranged in this order from the catalyst layer side in the direction away from the catalyst layer in the base material. Consequently, water in the electrode can be efficiently removed, and the output of the fuel cell can be enhanced. Thus, a thin fuel cell electrode can be produced.

In accordance with the present invention, there is provided a method for manufacturing a liquid fuel supply type fuel cell comprising a fuel electrode and an oxidizer electrode, a solid electrolyte membrane placed between the fuel electrode and the oxidizer electrode, and a liquid fuel supply section for supplying liquid fuel to the fuel electrode, the method comprising the steps of forming the oxidizer electrode according to the method for manufacturing an electrode for a fuel cell described above, and pressure-bonding the oxidizer electrode, the solid electrolyte membrane and the fuel electrode stacked in this order.

According to the method for manufacturing a fuel cell, it is possible to manufacture a fuel cell in which water in the oxidizer electrode can be promptly removed, and a gas diffusion path in the oxidizer electrode can be secured. Thus, a liquid fuel supply type fuel cell excellent in water removal efficiency and output characteristics can be produced stably. Further, a thinner, smaller and lighter liquid fuel supply type fuel cell can be produced.

### BRIEF DESCRIPTION OF THE DRAWINGS

FIG. 1 is a cross section diagram schematically showing the construction of a fuel cell according to an embodiment of the present invention.

FIG. 2 is a cross section diagram schematically showing the construction of the fuel cell according to the embodiment of the present invention.

FIG. 3 is a cross section diagram schematically showing the base material of an oxidizer electrode according to the embodiment of the present invention.

Incidentally, the reference numeral 100 represents a fuel cell; the reference numeral 101 represents a single cell structure; the reference numeral 102 represents a fuel electrode; the reference numeral 104 represents a base material; the reference numeral 106 represents a catalyst layer; the reference numeral 108 represents an oxidizer electrode; the reference numeral 110 represents a base material; the reference numeral 112 represents a catalyst layer; the reference numeral 114 represents a solid electrolyte membrane; the reference numeral 120 represents a fuel electrode side separator; the reference numeral 122 represents an oxidizer electrode side separator; the reference numeral 124 represents fuel; the reference numeral 126 represents an oxidizing agent; the reference numeral 441 represents a hydrophobic layer; and the reference numeral 443 represents a hydrophilic layer.

### BEST MODE FOR CARRYING OUT THE INVENTION

A fuel cell according to an embodiment of the present invention comprises a fuel electrode, an oxidizer electrode and a solid electrolyte membrane. The pair of the fuel electrode and the oxidizer electrode are called catalyst electrodes. Each of the catalyst electrodes includes a base material and a catalyst layer formed between the base material and the solid electrolyte membrane. In the base material of the oxidizer electrode, a first layer having hydrophobic properties and a second layer having hydrophilic properties are arranged in this order from the catalyst layer side toward the outside of the cell.

In the fuel cell of the present invention, the base material may be formed of porous conductive material. With this construction, it is possible to secure a water removal path as well as a gas diffusion path in the base material. Thereby, the output of the fuel cell can be enhanced.

In the fuel cell of the present invention, the base material may be formed of carbon paper or foam metal. With this construction, the conductivity of the base material is suitably ensured, and also a water removal path as well as a gas diffusion path in the base material is maintained. Thereby, the output of the fuel cell can be further enhanced.

In the fuel cell of the present invention, the first layer may include a water repellent resin. With this construction, it is possible to secure a more suitable path for leading water in the catalyst layer of the oxidizer electrode from the first layer to the second layer. Consequently, water in the catalyst layer is promptly led into the base material, and therefore, the water can be efficiently removed. Thus, the output of the fuel cell can be enhanced.

In the fuel cell of the present invention, the water repellent resin may include a fluorine-containing resin. With this construction, water in the catalyst layer is further promptly led into the base material, and therefore, the water can be efficiently removed. Thus, the output of the fuel cell can be further enhanced.

In the fuel cell of the present invention, the second layer may be formed by roughening the surface of the base material. With this construction, it is possible to secure a path for moving water led to the second layer promptly to the outside surface of the base material. In addition, since the surface of the base material is roughened, the water which has reached the surface of the base material can evaporate quickly. Consequently, water in the oxidizer electrode can be efficiently removed, and the output of the fuel cell can be enhanced.

In the fuel cell of the present invention, the second layer may be formed by sandblasting the base material. With this construction, since the outside surface of the base material is roughened, it is possible to secure a path for moving water promptly and evaporate the water efficiently from the surface. Thus, the output of the fuel cell can be further enhanced.

In the fuel cell of the present invention, the second layer may be formed by applying acid treatment to the base material. With this construction, the surface of the base material is roughened, and hydrogen is introduced into the base material. Consequently, the base material can be more hydrophilic. Also it is possible to secure a path for moving water promptly and evaporate the water efficiently from the surface. Thus, the output of the fuel cell can be further enhanced.

In the fuel cell of the present invention, a third layer having hydrophobic properties may be formed in the direction from the second layer toward the outside of the cell.

In the fuel cell of the present invention, water led to the second layer can evaporate efficiently from the third layer to the outside of the cell. Consequently, water in the oxidizer electrode can be efficiently removed. Additionally, since a gas diffusion path in the oxidizer electrode is maintained, the output of the fuel cell can be enhanced.

In the fuel cell of the present invention, the third layer may include a water repellent resin. With this construction, water in the base material can evaporate quickly from the third layer, and be removed out of the cell. Consequently, water in the oxidizer electrode can be promptly removed, and the output of the fuel cell can be enhanced.

In the fuel cell of the present invention, the water repellent resin may include a fluorine-containing resin. With this construction, water in the base material can evaporate more quickly from the third layer, and be efficiently removed out of the cell. Consequently, water in the oxidizer electrode can be efficiently removed, and the output of the fuel cell can be further enhanced.

In the fuel cell electrode of the present invention, the base material may be formed of porous conductive material. With this construction, it is possible to secure a water removal path as well as a gas diffusion path in the base material. Thereby, the output of a fuel cell with the electrode can be enhanced.

In the fuel cell electrode of the present invention, the base material may be formed of carbon paper or foam metal. With this construction, the conductivity of the base material is suitably ensured, and also a water removal path as well as a gas diffusion path in the base material is maintained. Thereby, the output of a fuel cell with the electrode can be further enhanced.

In the fuel cell electrode of the present invention, the first layer may include a water repellent resin. With this construction, it is possible to secure a more suitable path for leading water in the catalyst layer from the first layer to the second layer. Consequently, water in the catalyst layer is promptly led into the base material, and therefore, the water can be efficiently removed. Thus, the output of a fuel cell with the electrode can be enhanced.

In the fuel cell electrode of the present invention, the water repellent resin may include a fluorine-containing resin. With this construction, water in the catalyst layer is further promptly led into the base material, and therefore, the water can be efficiently removed. Thus, the output of a fuel cell with the electrode can be further enhanced.

In the fuel cell electrode of the present invention, the second layer may be formed by roughening the surface of the base material. Through the use of this electrode for a fuel cell, it is possible to secure a path for moving water led to the second layer promptly to the outside surface of the base material. In addition, since the surface of the base material is roughened, the water which has reached the surface of the base material can evaporate quickly. Consequently, water in the oxidizer electrode can be efficiently removed, and the output of a fuel cell with the electrode can be enhanced.

In the fuel cell electrode of the present invention, the second layer may be formed by sandblasting the base material. With this construction, since the surface of the base material on the opposite side of the catalyst layer is roughened, it is possible to secure a path for moving water promptly and evaporate the water efficiently from the surface. Thus, the output of a fuel cell with the electrode can be further enhanced.

In the fuel cell electrode of the present invention, the second layer may be formed by applying acid treatment to the base material. With this construction, the surface of the base material is roughened, and hydrogen is introduced into the base material. Consequently, the base material can be more hydrophilic. Also it is possible to secure a path for moving water promptly and evaporate the water efficiently from the surface. Thus, the output of a fuel cell with the electrode can be further enhanced.

In the fuel cell electrode of the present invention, a third layer having hydrophobic properties may be formed on the second layer in the direction away from the catalyst layer. In a fuel cell with the electrode of the present invention, water led to the second layer can evaporate efficiently from the third layer to the outside of the cell. Consequently, water in the oxidizer electrode can be efficiently removed. Additionally, since a gas diffusion path in the oxidizer electrode is maintained, the output of the fuel cell with the electrode can be enhanced.

In the fuel cell electrode of the present invention, the third layer may include a water repellent resin. With this construction, water in the base material can evaporate quickly from the third layer, and be removed out of the cell. Consequently, water in the electrode can be efficiently removed, and the output of a fuel cell with the electrode can be enhanced.

In the fuel cell electrode of the present invention, the water repellent resin may include a fluorine-containing resin. With this construction, water in the base material can evaporate more quickly from the third layer, and be efficiently removed out of the cell. Consequently, water in the electrode can be efficiently removed, and the output of a fuel cell with the electrode can be further enhanced.

According to the method for manufacturing a fuel cell electrode of the present invention, the step of forming the hydrophilic layer on one surface of the base material may involve surface roughening of the base material. By this means, it is possible to form the surface from which water in the electrode evaporates efficiently and is removed out of the electrode. Consequently, through the use of the fuel cell electrode obtained by the manufacturing method, the output of a fuel cell can be enhanced.

According to the method for manufacturing a fuel cell electrode of the present invention, the step of forming the hydrophilic layer on one surface of the base material may involve sandblasting. By this means, the hydrophilic layer is roughened, and it is possible to form the surface from which water in the electrode evaporates efficiently and is removed out of the electrode. Thus, through the use of the fuel cell electrode obtained by the manufacturing method, the output of a fuel cell can be enhanced.

According to the method for manufacturing a fuel cell electrode of the present invention, the step of forming the hydrophilic layer on one surface of the base material may involve acid treatment. By this means, the hydrophilic layer is roughened, and hydrogen is introduced into the base material. Consequently, water in the electrode can be efficiently led to the surface, evaporate therefrom, and removed out of the electrode. Thus, through the use of the fuel cell electrode obtained by the manufacturing method, the output of a fuel cell can be further enhanced.

The method for manufacturing a fuel cell electrode of the present invention further comprises, after the step of forming the hydrophilic layer on one surface of the base material, the step of forming the hydrophobic layer on the surface of the hydrophilic layer.

In a fuel cell electrode obtained by the manufacturing method, water led to the second layer can evaporate efficiently from the third layer to the outside of the cell. Consequently, water in the electrode can be efficiently removed. Additionally, since a gas diffusion path in the electrode is maintained, the output of a fuel cell with the fuel cell electrode can be enhanced.

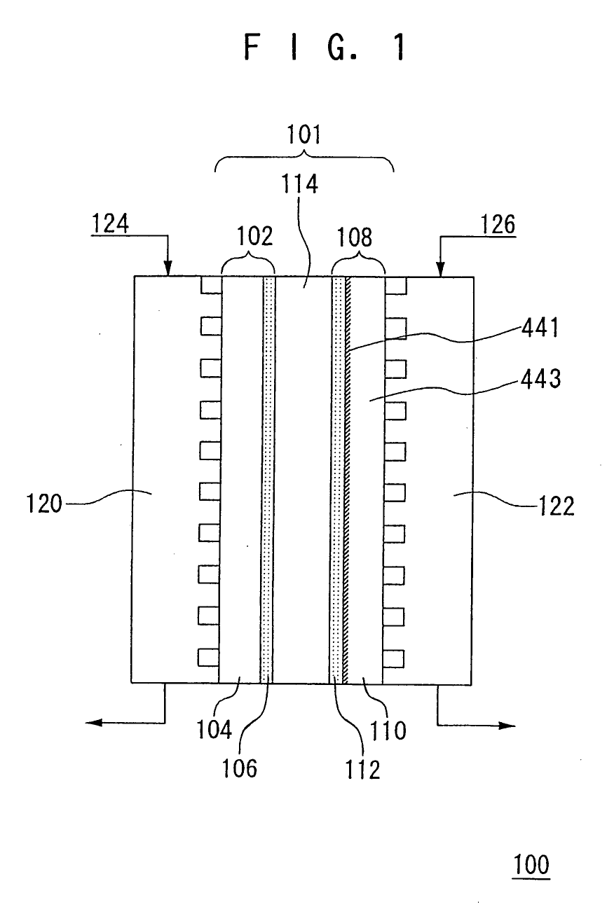

FIG. 1 is a cross section diagram schematically showing the single cell structure of a fuel cell according to an embodiment of the present invention. A fuel cell 100 has single cell structures 101. Each of the single cell structures 101 comprises a fuel electrode 102, an oxidizer electrode 108, and a solid electrolyte membrane 114. The fuel electrode 102 of the single cell structure 101 is supplied with fuel 124 through a fuel electrode side separator 120. On the other hand, the oxidizer electrode 108 of the single cell structure 101 is supplied with an oxidizing agent 126 through an oxidizer electrode side separator 122.

The fuel electrode 102 and the oxidizer electrode 108 include catalyst layers 106 and 112 formed on base materials 104 and 110, respectively. In the base material 110 constituting the oxidizer electrode 108, a first layer having hydrophobic properties and a second layer having hydrophilic properties are formed in the direction from the catalyst layer 112 side to the outside of the cell. Incidentally, the direction to “the outside of the cell” indicates the direction away from the solid electrolyte membrane 114.

For example, in FIG. 1, the base material 110 is provided with a hydrophobic layer 441 on the surface in contact with the catalyst layer 112 and a hydrophilic layer 443 more outside than the hydrophobic layer 441.

Incidentally, the hydrophilic layer 443 may be formed in the entire base material except for the hydrophobic layer 441 as shown in FIG. 1, or may be formed only in the vicinity of the surface where the catalyst layer 112 is not formed.

With this construction, water in the catalyst layer 112 of the oxidizer electrode 108 can be promptly led from the hydrophobic layer 441 in contact with the catalyst layer 112 into the base material 110 or the hydrophilic layer 443, and evaporate from the outside surface of the base material 110.

As contrasted with the hydrophobic layer 441, the surface of the hydrophilic layer 443 is roughened. By this means, water led from the hydrophobic layer 441 to the hydrophilic layer 443 can evaporate more quickly.

As an index of the hydrophilicity of the hydrophilic layer 443 in contrast to the hydrophobic layer 441, for example, the following conditions may be satisfied: Ra₂<Ra₁ where Ra₁ is the center line average roughness of the surface where the hydrophilic layer 443 is formed and Ra₂ is the center line average roughness of the surface where the hydrophobic layer 441 is formed. That is, the surface of the hydrophilic layer 443 for the evaporation of water can be made rougher than that of the hydrophobic layer 441 for the discharge of water into the base material 110. With this construction, water in the catalyst layer 112 of the oxidizer electrode 108 can be promptly discharged from the hydrophobic layer 441 into the base material 110. Thus, the water can evaporate quickly from the other surface and be removed.

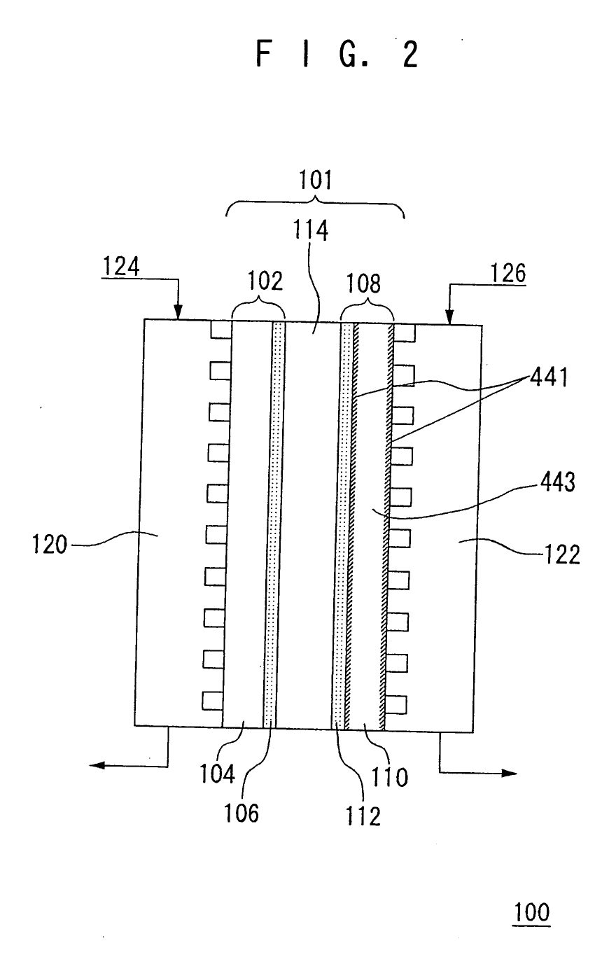

FIG. 2 is a diagram showing another example of the fuel cell according to this embodiment of the present invention. In FIG. 2, the hydrophobic layers 441 are provided to both the surfaces of the base material 110 with the hydrophilic layer 443 between them.

As just described, in the fuel cell of this embodiment, a third layer having hydrophobic properties may be formed in the direction from the second layer having hydrophilic properties toward the outside of the cell. With this construction, water in the catalyst layer 112 of the oxidizer electrode 108 can be promptly discharged from the hydrophobic layer 441 into the base material 110, and led to the hydrophilic layer 443. Thus, the water can evaporate efficiently from the outside hydrophobic layer 441.

In the case where the hydrophobic layers 441 are provided to both the surfaces of the base material 110, the inside hydrophobic layer 441 may be made more hydrophobic as compared to the other so that water can be more efficiently removed.

Incidentally, in the fuel cell of this embodiment, water can be further efficiently removed by applying water repellency to the hydrophobic layer 441.

As set forth hereinabove, in a fuel cell of the present invention, a hydrophilic layer and a hydrophobic layer are provided in one base material of the oxidizer electrode. Consequently, the fuel cell can be thinner as compared to the conventional fuel cell in which a plurality of base materials are stacked. Besides, good electrical contact can be maintained as compared to the conventional fuel cell in which a plurality of base materials are stacked.

As the base materials 104 and 110, porous base materials, such as carbon paper, carbon molding, carbon sinter, sintered metal, and foam metal, may be used. In the case where foam metal is used as the base materials 104 and 110, for example, stainless steel or nickel metal may be employed. With stainless-steel foam metal, resistance to liquid fuel is favorably maintained especially in the fuel electrode. Thus, the durability and safety of the fuel electrode can be improved.

As examples of the catalyst of the fuel electrode 102 may be cited platinum, rhodium, palladium, iridium, osmium, ruthenium, rhenium, gold, silver, nickel, cobalt, lithium, lanthanum, strontium, yttrium, and the like, and they may be used alone or in a combination of two or more. On the other hand, as the catalyst of the oxidizer electrode 108, similar materials to those for the catalyst of the fuel electrode 102 may be utilized, and the materials previously cited as examples can be employed. The same material or different materials may be used for the catalysts of the fuel electrode 102 and oxidizer electrode 108.

As examples of carbon particles for holding the catalyst may be cited acetylene black (for example, Denka Black (registered trade name) made by Denki Kagaku Kogyo Kabushiki Kaisha, XC72 made by Vulcan Material Company, and the like), Ketjen Black, amorphous carbon, carbon nanotube, carbon nanohorn, and the like. The carbon particles may have a diameter not less than 0.01 μm and not more than 0.1 μm, preferably not less than 0.02 μm and not more than 0.06 μm.

The solid polyelectrolyte constituting the catalyst electrodes of this embodiment electrically connects the carbon particles holding the catalyst and the solid electrolyte membrane 114 on the surfaces of the catalyst electrodes, and brings organic liquid fuel to the surfaces of the catalysts. This requires the solid polyelectrolyte to have hydrogen ion conductivity and water-moving capability. Additionally, in the fuel electrode 102, the solid polyelectrolyte is required to have the permeability to organic liquid fuel such as methanol, while in the oxidizer electrode 108, the solid polyelectrolyte is required to have the oxygen permeability. In order to satisfy such requirements, materials excellent in hydrogen ion conductivity and the permeability to organic liquid fuel such as methanol are suitably used to form the solid polyelectrolyte.

More specifically, organic polymers having a polar group such as a strong acid group including a sulfone group and a phosphate group or a weak acid group including a carboxyl group are suitably used. Examples of such organic polymers include: perfluorocarbone containing a sulfone group (Nafion made by DuPont, Aciplex made by Asahi Kasei Corporation, etc.); perfluorocarbone containing a carboxyl group (Flemion S film made by Asahi Glass Co., Ltd., etc.); copolymers such as polystyrene sulfonic acid copolymer, polyvinyl sulfonic acid copolymer, cross-linked alkyl sulfonic acid derivative, fluorine-containing polymer composed of a fluoropolymer skeleton and sulfonic acid; and a copolymer obtained by copolymerization of acrylic amides such as acrylic amid-2-methylpropane sulfonic acid and acrylates such as n-butyl methacrylate.

In addition, examples of polymers to which the polar group is attached include: resins having a hydroxyl group or nitrogen, for instance, nitrogen substituted polyacrylate such as diethylaminoethyl polymethacrylate and amine substituted polystyrene including polybenzimidazole derivative, polybenzoxazole derivative, cross-linked polyethyleneimine, polythiramine derivative, and polydiethylaminoethyl polystyrene; polyacryl resins containing a hydroxyl group typified by silanol-containing polysiloxane and hydroxylethyl polymethylacrylate; and polystyrene resins containing a hydroxyl group typified by para-hydroxy polystyrene.

If necessary, a cross-linking substituent, for example, a vinyl group, an epoxy group, an acrylic group, a methacrylic group, a cinnamoil group, a methylol group, an azido group or a naphthoquinonediazido group may be introduced into the polymers described above.

The same material or different materials may be used for the solid polyelectrolyte of the fuel electrode 102 and oxidizer electrode 108.

The solid electrolyte membrane 114 separates the fuel electrode 102 from the oxidizer electrode 108, and forces hydrogen ions to migrate between both the electrodes. For this action, the solid electrolyte membrane 114 preferably has high hydrogen ion conductivity. Also preferably, the solid electrolyte membrane 114 is chemically stable and mechanically strong.

As materials for the solid electrolyte membrane 114, organic polymers having a polar group such as a strong acid group including a sulfone group, a phosphate group, a phosphone group and a phosphine group or a weak acid group including a carboxyl group are suitably used. Examples of such organic polymers include: polymers containing aromatic series such as sulfonated poly (4-phenoxybenzoil-1,4-phenylene), alkyl sulfonated polybenzoimidazol; copolymers such as polystyrene sulfonic acid copolymer, polyvinyl sulfonic acid copolymer, cross-linked alkyl sulfonic acid derivative, fluorine-containing polymer composed of a fluoropolymer skeleton and sulfonic acid; a copolymer obtained by copolymerization of acrylic amides such as acrylic amid-2-methylpropane sulfonic acid and an acrylates such as n-butyl methacrylate; perfluorocarbone containing a sulfone group (for example, Nafion (registered trade name) made by DuPont, Aciplex (registered trade name) made by Asahi Kasei Corporation); and perfluorocarbone containing a carboxyl group (for example, Flemion S film made by Asahi Glass Co., Ltd.). In the case of selecting a polymer containing aromatic series such as sulfonated poly (4-phenoxybenzoil-1,4-phenilyene) or alkyl sulfonic polybenzoimidazol, the transmission of the organic liquid fuel can be limited, which prevents a reduction in cell efficiency due to cross-over.

Besides, the fuel cell of this embodiment is supplied with liquid fuel. The organic compound contained in the liquid fuel includes hydrogen atoms. For example, alcohols such as methanol, ethanol and propanol, ethers such as dimethyl ether, cycloparaffins such as cyclohexane, cycloparaffins having a hydrophilic group such as a hydroxyl group, a carboxyl group, an amino group and an amide group, mono- and di-substituted cycloparaffin or the like may be used. In the foregoing, the cycloparaffins include cycloparaffin and substituents thereof but aromatic compounds. As oxidizing agents, for example, oxygen, air and the like may be utilized.

While there are no special limitations upon methods for manufacturing the fuel cell of this embodiment, the fuel cell may be manufactured as follows.

First, a description will be given of a method for forming the hydrophobic layer and the hydrophilic layer in the base material constituting the oxidizer electrode. The following processes may be cited as examples for forming the hydrophobic layer and the hydrophilic layer in the base material.
(i) Hydrophilic treatment is applied to the entire base material before hydrophobic treatment is applied to one surface of the base material
(ii) Hydrophilic treatment is applied to one surface of the base material and hydrophobic treatment is applied to the other surface of the base material
(iii) Hydrophobic treatment is applied to the entire base material before hydrophilic treatment is applied to one surface of the base material

Further, according to this embodiment, the hydrophobic layers may be formed on both the surfaces of the base material with the hydrophilic layer between them. Such base material may be formed as follows.
(iv) Hydrophilic treatment is applied to the entire base material before hydrophobic treatment is applied to both the surfaces of the base material

In the above processes, water repellency is applied to the base material by the hydrophobic treatment. Accordingly, water is further efficiently removed.

In the above processes (i) to (iv), the process for applying the hydrophilic treatment to the base material may involves surface roughening. A chemical method, a physical method or a combination of these may be employed for roughening the surface of the base material and applying hydrophilic properties thereto. As the chemical method, for example, the base material may be dipped into or brought into contact with concentrated sulfuric acid, concentrated nitric acid or the like. Further, methods such as electrolytic oxidation and steam oxidation may also be utilized. Through these methods, hydrogen is introduced into the surface of the base material, which improves the affinity of the surface for water.

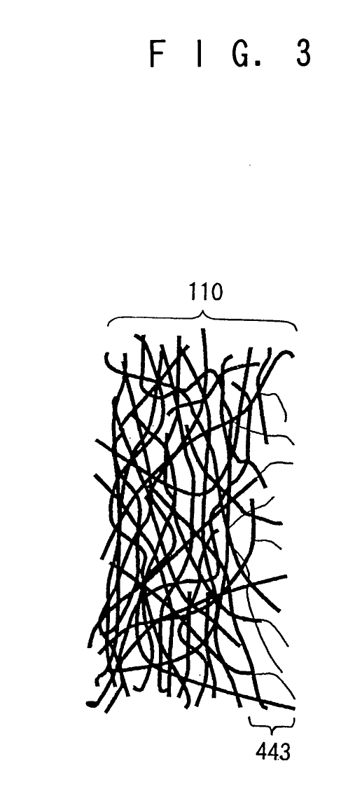

As the physical method of roughening the surface of the base material and applying hydrophilic properties thereto, fine granules containing fine carbon fibers or fine carbon particles may be blown against the surface of the base material by sandblasting. The average diameter of the fine granules may be, for example, not less than 0.01 μm and not more than 0.2 μm. Since the surface treated by sandblasting is roughened as for example shown in FIG. 3, a water migration path can be suitably secured as compared to an untreated surface. Additionally, water can evaporate quickly from the treated surface, and thereby being efficiently removed.

As the method of applying hydrophilic properties to the base material, plasma treatment using, for example, O₂, N₂, Ar or the like may be employed.

These methods can improve an affinity for water without increasing specific electrical resistance as compared such conventional method as is described in Japanese Patent Application laid open No. HEI9-245800, in which an insulating material such as SiO₂ is used for hydrophilic treatment. Consequently, water in the catalyst layer is efficiently led to the hydrophilic layer through the hydrophobic layer, and evaporated from the surface of the base material.

In addition, with a combination of the above-described chemical method and physical method, it is possible to further improve efficiency in the evaporation of water from the hydrophilic layer on the surface of the oxidizer electrode. For example, by applying hydrophilic treatment with the aforementioned acids or the like to the sandblasted base material, a large surface area having a high affinity for water can be obtained.

As is described above, in the fuel cell of this embodiment, the hydrophilic layer is roughened. Consequently, water in the catalyst layer of the oxidizer electrode can be removed with higher-level efficiency, and evaporated from the surface of the base material. Thus, the output of the fuel cell can be further enhanced.

Besides, in the above processes (i) to (iv), as the method of applying the hydrophobic treatment to the base material, for example, the base material may be dipped into or brought into contact with a solution or a suspension of a hydrophobic material such as polyethylene, paraffin, polydimethylsiloxane, PTFE, tetrafluoroethylene-perfluoroalkyl vinyl ether copolymer (PFA), fluorinated ethylene propylene (FEP), poly (perfluorooctylethyl acrylate) (FMA), and polyphosphazene. Especially, through the use of a highly water repellent material such as PTFE, tetrafluoroethylene-perfluoroalkyl vinyl ether copolymer (PFA), fluorinated ethylene propylene (FEP), poly (perfluorooctylethyl acrylate) (FMA), and polyphosphazene, a desirable hydrophobic layer can be formed.

The base material may be coated with paint made from hydrophobic material, such as PTFE, PFA, FEP, pitch fluoride and polyphosphazene, ground to a powder and suspended in a solvent. The paint may be a mixed suspension of hydrophobic material and conductive material such as metal and carbon. Also the paint may be made from a conductive fiber having water repellency (for example, dreamalon (registered trade name) made by Nissen Co., Ltd.) ground to a powder and suspended in a solvent. As just described, through the use of conductive and water repellent material, the output of the fuel cell can be further enhanced.

The base material may also be coated with paint made from conductive material such as metal and carbon ground to a powder and suspended in the aforementioned paint made from hydrophobic material.

There are no special limitations upon coating methods, and methods such as brush application, spray application and screen printing may be employed.

Additionally, a hydrophobic group is introduced into the surface of the base material by plasma treatment. By this means, the hydrophobic layer may be formed in desired thickness. In the case of, for example, the above process (iv), if the hydrophobic layer not contacted by the catalyst layer is made thinner, water that has passed through the gaseous hydrophilic layer can evaporate more quickly. For example, the hydrophobic layer not contacted by the catalyst layer may be not less than 10 μm and not more than 100 μm in thickness.

By applying, for example, CF₄ plasma treatment to the surface of gas, water repellency is applied to the surface of the base material. Thus, efficiency in the evaporation of water can be improved.

In the case of the above process (iii), a conductive and water repellent base material may be obtained by mixing water repellent resin such as PTFE with conductive material such as carbon particles, forming the mixture into a plate and drying it. After that, by roughening the surface of the base material thus obtained, the hydrophilic layer can be formed.

The catalysts of the fuel electrode and the oxidizer electrode can be held by carbon particles by impregnation which is generally performed. Then, the carbon particles holding the catalysts and solid polyelectrolyte particles are dispersed in a solvent to make a paste. After that, the paste is coated on the base material, and dried to obtain the fuel electrode and the oxidizer electrode. The diameter of the carbon particle is set to, for example, not less than 0.01 μm and not more than 0.1 μm. The diameter of catalyst particle is set to, for example, not less than 1 nm and not more than 10 nm. Further, the diameter of the solid polyelectrolyte particle is set to, for example, not less than 0.05 μm and not more than 1 μm. The carbon particles and the solid polyelectrolyte particles are used, for example, at a weight ratio in the range of 2:1 to 40:1. Also, the weight ratio of water to solute in the paste is, for example, in the range of about 1:2 to 10:1.

Although not particularly limited, the paste may be coated on the base material through brush application, spray application, screen printing or the like. The paste is coated in a thickness of approximately not less than 1 μm and not more than 200 μm. For the oxidizer electrode, the paste is coated on the hydrophobic surface formed through any of the methods previously described. After being coated with the paste, the base material is heated at temperature and for the period of time corresponding to the type of fluorocarbon resin used to fabricate the fuel electrode and the oxidizer electrode. The heating temperature and heating time are appropriately determined according to materials used. For example, the heating temperature may be not less than 100° C. and not more than 250° C., while the heating time may be not less than 30 seconds and not more than 30 minutes.

The solid electrolyte membrane of this embodiment can be fabricated by using a method suitable for a material used. For example, when made from an organic polymer material, the solid electrolyte membrane can be obtained by casting and drying a liquid comprised of a solvent and the organic polymer material dissolved or dispersed therein on a removable sheet made of polytetrafluoroethylene or the like.

The solid electrolyte membrane thus obtained is interposed between the fuel electrode and the oxidizer electrode, and hot pressed to produce a laminated catalyst electrode-solid electrolyte membrane structure. In this event, the solid electrolyte membrane is made in contact with the surfaces of both the catalyst electrodes on which the catalysts are provided. The conditions for the hot pressing are selected depending on particular materials. When the solid polyelectrolytes on the surfaces of the solid electrolyte membrane and the catalyst electrodes are formed of organic polymers each having a softening point or a glass transition point, the hot pressing can be conducted at a temperature exceeding the softening temperature or glass transition temperature of these organic polymers. More specifically, the hot pressing may be conducted under the following conditions: temperature from not less than 100 to not more than 250° C.; pressure from not less than 1 to not more than 100 kg/cm²; and duration from not less than 10 to not more than 300 seconds.

### EXAMPLES

In the following, a concrete description will be given of the fuel cell and the method for manufacturing the same of this embodiment with reference to the particular illustrative examples. However, the present invention is not to be restricted by the examples.

### Example 1

In the fuel cell of this example, a hydrophobic layer and a hydrophilic layer were formed on the surface of the base material of the oxidizer electrode, and a catalyst layer was formed on the hydrophobic layer.

Carbon paper (TGP-H-120 made by Toray Industries, Inc.) of 2×2 cm with a thickness of 0.3 mm was used for the base materials of both the fuel electrode and the oxidizer electrode. For the fuel electrode, the carbon paper was used without any treatment. For the oxidizer electrode, the following treatment was conducted.

One surface of the carbon paper was brought in contact with a solution prepared by adjusting the dispersion liquid of PTFE (PTFE 30-J made by DuPont) to 6 wt %, and dried at 200° C. to form the hydrophobic layer. The other surface of the carbon paper was brought in contact with concentrated sulfuric acid (97 wt %), and dried at 120° C. after being washed to prepare the hydrophilic layer.

The catalyst layers for the fuel electrode and the oxidizer electrode were formed as follows. An amount of 100 mg of Ketjen Black holding a ruthenium-platinum alloy was added to a 5% solution of Nafion, made by Aldrich Chemical Company, Inc., and stirred by an ultrasonic mixer for three hours at 50° C. to produce a catalyst paste. The alloy contained 50 atom % Ru, and the weight ratio of the alloy to the carbon particles is 1:1. This paste was coated in a thickness of 2 mg/cm² on the respective carbon papers, and dried at 120° C. to prepare the catalyst electrodes.

The catalyst electrodes were bonded by thermo press bonding to both the surfaces of a membrane made of Nafion 117 (registered trade name) made by DuPont at 120° C. to obtain a laminated catalyst electrode-solid electrolyte membrane structure to be the fuel cell.

A 10% v/v methanol solution and oxygen gas were supplied as fuel to the fuel cell at 2 cc/min and 30 cc/min, respectively, and cell characteristics were measured. As a result, the fuel cell generated a voltage of 0.4 V at a current density of 100 mA/cm². No significant change was observed in the cell characteristics after a lapse of 12 hours.

### Reference Example 1

A fuel cell was prepared in much the same manner as in Example 1. In Reference Example 1, however, hydrophilic treatment and hydrophobic treatment were not applied to the base material of the oxidizer electrode, and an untreated carbon paper (TGP-H-120 made by Toray Industries, Inc.) of 2×2 cm was utilized.

A 10% v/v methanol solution and oxygen gas were supplied as fuel to the fuel cell at 2 cc/min and 30 cc/min, respectively, and cell characteristics were measured. As a result, the fuel cell generated a voltage of 0.4 V at a current density of 100 mA/cm², and the voltage fell to 0.35 V after a lapse of 12 hours. That is, used for long hours, the fuel cell reduces its output.

### Reference Example 2

A fuel cell was prepared in much the same manner as in Example 1. In Reference Example 2, however, hydrophilic treatment was not applied to the base material of the oxidizer electrode, and only hydrophobic treatment was applied to one surface of the base material to prepare a hydrophobic layer. The hydrophobic layer was formed in the same manner as in Example 1.

Catalyst layers for the fuel electrode and the oxidizer electrode were formed in the same manner as in Example 1. The catalyst electrodes thus obtained were bonded by thermo press bonding to both the surfaces of a membrane made of Nafion 117 (registered trade name) made by DuPont at 120° C. to obtain a laminated catalyst electrode-solid electrolyte membrane structure to be the fuel cell.

A 10% v/v methanol solution and oxygen gas were supplied as fuel to the fuel cell at 2 cc/min and 30 cc/min, respectively, and cell characteristics were measured. As a result, the fuel cell generated a voltage of 0.4 V at a current density of 100 mA/cm², and the voltage fell to 0.37 V after a lapse of 12 hours. That is, used for long hours, the fuel cell reduces its output.

### Example 2

In this example, hydrophilic treatment was applied to the entire base material of the oxidizer electrode. After that, a hydrophobic layer was formed on one surface of the base material, and a catalyst layer was formed on the hydrophobic layer.

Carbon paper (TGP-H-120 made by Toray Industries, Inc.) of 2×2 cm with a thickness of 0.3 mm was used for the base materials of both the fuel electrode and the oxidizer electrode. For the fuel electrode, the carbon paper was used without any treatment. For the oxidizer electrode, the following treatment was conducted.

The carbon paper was dipped into concentrated sulfuric acid (97 wt %), and dried at 120° C. after being washed for hydrophilic treatment. Subsequently, one surface of the carbon paper was coated with a solution prepared by adjusting the dispersion liquid of PTFE (PTFE 30-J made by DuPont) to 6 wt % by spray application, and dried at 200° C. to form the hydrophobic layer.

The catalyst layers for the fuel electrode and the oxidizer electrode were formed in the same manner as in Example 1. The catalyst electrodes thus obtained were bonded by thermo press bonding to both the surfaces of a membrane made of Nafion 117 (registered trade name) made by DuPont at 120° C. to obtain a laminated catalyst electrode-solid electrolyte membrane structure to be the fuel cell.

A 10% v/v methanol solution and oxygen gas were supplied as fuel to the fuel cell at 2 cc/min and 30 cc/min, respectively, and cell characteristics were measured. As a result, the fuel cell generated a voltage of 0.4 V at a current density of 100 mA/cm². No significant change was observed in the cell characteristics after a lapse of 12 hours.

### Example 3

In this example, hydrophilic treatment was applied to the entire base material of the oxidizer electrode. After that, hydrophobic treatment was applied to both the surfaces of the base material, and a catalyst layer was formed on one of the surfaces. In the case of this example, hydrophobic layers were formed with a hydrophilic layer between them.

Carbon paper (TGP-H-120 made by Toray Industries, Inc.) of 2×2 cm with a thickness of 0.3 mm was used for the base materials of both the fuel electrode and the oxidizer electrode. For the fuel electrode, the carbon paper was used without any treatment. For the oxidizer electrode, the following treatment was conducted.

The carbon paper was dipped into concentrated sulfuric acid (97 wt %), and dried at 120° C. after being washed for hydrophilic treatment. Subsequently, both the surfaces of the carbon paper were brought in contact one by one with a solution prepared by adjusting the dispersion liquid of PTFE (PTFE 30-J made by DuPont) to 6 wt %, and dried at 200° C. to form the hydrophobic layers on the respective surfaces.

The catalyst layers for the fuel electrode and the oxidizer electrode were formed in the same manner as in Example 1. The catalyst electrodes thus obtained were bonded by thermo press bonding to both the surfaces of a membrane made of Nafion 117 (registered trade name) made by DuPont at 120° C. to obtain a laminated catalyst electrode-solid electrolyte membrane structure to be the fuel cell.

A 10% v/v methanol solution and oxygen gas were supplied as fuel to the fuel cell at 2 cc/min and 30 cc/min, respectively, and cell characteristics were measured. As a result, the fuel cell generated a voltage of 0.4 V at a current density of 100 mA/cm². No change was observed in the cell characteristics after a lapse of 12 hours.

### Example 4

In this example, a hydrophobic layer and a hydrophilic layer were formed on the surface of the base material of the oxidizer electrode, and a catalyst layer was formed on the hydrophobic layer.

SUS foam metal (made by Mitsubishi Materials Corporation) of 2×2 cm with a thickness of 0.3 mm was used for the base materials of both the fuel electrode and the oxidizer electrode. For the fuel electrode, the SUS foam metal was used without any treatment. For the oxidizer electrode, the following treatment was conducted.

Carbon particles, averaging 1 μm in diameter, were blown against one surface of the SUS foam metal by sandblasting for hydrophilic treatment. Then, the degree of roughness of the sandblasted surface was estimated. The center line average roughness (Ra) of the surface of the base material ranged from 10 to 15 μm, while Ra of the untreated surface ranged from 3 to 6 μm. Thus, it was confirmed that the surface had been roughened by sandblasting. After that, the surface of the SUS foam metal was brought in contact with a solution prepared by adjusting the dispersion liquid of PTFE (PTFE 30-J made by DuPont) to 6 wt %, and dried at 200° C. to form the hydrophobic layer.

The catalyst layers for the fuel electrode and the oxidizer electrode were formed in the same manner as in Example 1. The catalyst electrodes thus obtained were bonded by thermo press bonding to both the surfaces of a membrane made of Nafion 117 (registered trade name) made by DuPont at 120° C. to obtain a laminated catalyst electrode-solid electrolyte membrane structure to be the fuel cell.

A 10% v/v methanol solution and oxygen gas were supplied as fuel to the fuel cell at 2 cc/min and 30 cc/min, respectively, and cell characteristics were measured. As a result, the fuel cell generated a voltage of 0.4 V at a current density of 100 mA/cm². No significant change was observed in the cell characteristics after a lapse of 12 hours.

The above Examples and Reference Examples proves that, in the fuel cell of this embodiment, the hydrophilic and hydrophobic layers formed in the base material of the oxidizer electrode facilitates the discharge and evaporation of water present in the oxidizer electrode. Thereby, the fuel cell achieves high output, and is prevented from reducing the output even when used for long hours.

### INDUSTRIAL APPLICABILITY

As set forth hereinabove, in accordance with the present invention, in a base material constituting the oxidizer electrode of a fuel cell, a first layer having hydrophobic properties and a second layer having hydrophilic properties are arranged in this order in the direction from a catalyst layer side to the outside of the cell. By virtue of this construction, water present in the oxidizer electrode of the fuel cell can be promptly evaporated and discharged out of the cell. Thus, in accordance with the present invention, it is possible to realize a fuel cell capable of achieving excellent water discharge efficiency in the oxidizer electrode and high output, catalyst electrodes for the fuel cell, and methods for manufacturing the same. Particularly, in accordance with the present invention, it is possible to realize a liquid fuel supply type fuel cell capable of achieving excellent efficiency in water discharge and evaporation in the oxidizer electrode, catalyst electrodes for the fuel cell, and methods for manufacturing the same.

1. A fuel cell comprising a solid electrolyte membrane, a fuel electrode and an oxidizer electrode with the solid electrolyte membrane between them, and a liquid fuel supply section for supplying liquid fuel to the fuel electrode, wherein:
the oxidizer electrode includes a base material and a catalyst layer formed between the base material and the solid electrolyte membrane; and
the base material includes therein a first layer having hydrophobic properties and a second layer having hydrophilic properties, which are arranged in this order in the direction from the catalyst layer side to the outside of the cell.

2. The fuel cell claimed in claim 1, wherein the base material is formed of porous conductive material.

3. The fuel cell claimed in claim 1, wherein the base material is formed of carbon paper or foam metal.

4. The fuel cell claimed in claim 1, wherein the first layer includes a water repellent resin.

5. The fuel cell claimed in claim 4, wherein the water repellent resin includes a fluorine-containing resin.

6. The fuel cell claimed in claim 1, wherein the second layer is formed by roughening the surface of the base material.

7. The fuel cell claimed in claim 6, wherein the second layer is formed by sandblasting the base material.

8. The fuel cell claimed in claim 6, wherein the second layer is formed by applying acid treatment to the base material.

9. The fuel cell claimed in claim 1, wherein the base material further includes therein a third layer having hydrophobic properties formed in the direction from the second layer toward the outside of the cell.

10. The fuel cell claimed in claim 9, wherein the third layer includes a water repellent resin.

11. The fuel cell claimed in claim 10, wherein the water repellent resin includes a fluorine-containing resin.

12. A fuel cell electrode for a liquid fuel supply type fuel cell comprising a base material and a catalyst layer formed on one surface of the base material, wherein the base material includes therein a first layer having hydrophobic properties and a second layer having hydrophilic properties, which are arranged in this order from the catalyst layer side in the direction away from the catalyst layer.

13. The fuel cell electrode claimed in claim 12, wherein the base material is formed of porous conductive material.

14. The fuel cell electrode claimed in claim 12, wherein the base material is formed of carbon paper or foam metal.

15. The fuel cell electrode claimed in claim 12, wherein the first layer includes a water repellent resin.

16. The fuel cell electrode claimed in claim 15, wherein the water repellent resin includes a fluorine-containing resin.

17. The fuel cell electrode claimed in claim 12, wherein the second layer is formed by roughening the surface of the base material.

18. The fuel cell electrode claimed in claim 17, wherein the second layer is formed by sandblasting the base material.

19. The fuel cell electrode claimed in claim 17, wherein the second layer is formed by applying acid treatment to the base material.

20. The fuel cell electrode claimed in claim 12, wherein the base material further includes therein a third layer having hydrophobic properties formed on the second layer in the direction away from the catalyst layer.

21. The fuel cell electrode claimed in claim 20, wherein the third layer includes a water repellent resin.

22. The fuel cell electrode claimed in claim 21, wherein the water repellent resin includes a fluorine-containing resin.

23. A method for manufacturing a fuel cell electrode for a liquid fuel supply type fuel cell, comprising:
forming a hydrophobic layer on one surface of a base material;
forming a hydrophilic layer on the other surface of the base material; and
forming a catalyst layer by coating the surface of the hydrophobic layer with paint containing conductive particles holding a catalyst material and particles including a solid polyelectrolyte.

24. The method for manufacturing a fuel cell electrode claimed in claim 23, wherein the forming the hydrophilic layer on the other surface of the base material comprises surface roughening of the base material.

25. The method for manufacturing a fuel cell electrode claimed in claim 23, wherein the forming the hydrophilic layer on the other surface of the base material involves sandblasting.

26. The method for manufacturing a fuel cell electrode claimed in claim 23, wherein the forming the hydrophilic layer on the other surface of the base material involves acid treatment.

27. The method for manufacturing a fuel cell electrode claimed in claim 23, further comprising, after the forming the hydrophilic layer on the other surface of the base material, the forming the hydrophobic layer on the surface of the hydrophilic layer.

28. A method for manufacturing a liquid fuel supply type fuel cell comprising a fuel electrode and an oxidizer electrode, a solid electrolyte membrane placed between the fuel electrode and the oxidizer electrode, and a liquid fuel supply section for supplying liquid fuel to the fuel electrode, the method comprising:
forming the oxidizer electrode according to the method for manufacturing a fuel cell electrode claimed in claim 23; and
pressure-bonding the oxidizer electrode, the solid electrolyte membrane and the fuel electrode stacked in this order.
